(19) United States
(12) Patent Application Publication
(10) Pub. No.: US 2006/0091181 A1
(43) Pub. Date: May 4, 2006

(54) Wire tensioner for a wire bonder

(75) Inventors: James E. Eder, Doylestown, PA (US); Michael J. Woodward, Ardsley, PA (US)

Correspondence Address: KULICKE AND SOFFA INDUSTRIES, INC., 2101 BLAIR MILL ROAD, WILLOW GROVE, PA, 19090, US

(73) Assignee: Kulicke and Soffa Industries, Inc.

(21) Appl. No.: 11/259,604

(22) Filed: Oct. 25, 2005

Related U.S. Application Data
(60) Provisional application No. 60/623,699, filed on Oct. 28, 2004.

(51) Int. Cl. B23K 37/00

(52) U.S. Cl. 228/4.5

(57) ABSTRACT

A wire tensioner for a wire bonding apparatus is provided. The wire tensioner includes a body structure defining a passage for receiving a wire, the passage including an inlet opening and an outlet opening through which the wire is configured to extend. The wire tensioner defines (1) an inlet port through which pressurized fluid is received into the wire tensioner, and (2) an exhaust port through which pressurized fluid is exhausted from the wire tensioner. The exhaust port is distinct from the inlet opening or the outlet opening of the body structure.

### RELATED APPLICATION

This application is related to and claims priority from U.S. Provisional Application No. 60/623,699, filed Oct. 28, 2004, entitled “Wire Tensioner for a Wire Bonder”, the disclosure of which is incorporated herein by reference in its entirety.

### FIELD OF THE INVENTION

The present invention relates to apparatuses for bonding wire, and more particularly, to a wire tensioner for a wire bonding apparatus.

### BACKGROUND OF THE INVENTION

In the electronics industry, conductive metal wire is used in a variety of devices, such as for connecting conductive leads on semiconductor devices. Exemplary materials used for wire bonding include gold, aluminum, copper, and silver. A wire bond is formed by attaching a length of wire between two contact locations. In order to form the attachment, various devices are used to sever and bond (e.g., melt) the wire ends to the contact location. Known wire bonding apparatuses include thermocompression (T/C), thermosonic (T/S) or ultrasonic (U/S) devices. The resulting length of bonded wire is typically curved along its length in a generally parabolic or elliptical configuration and is, therefore, referred to as a wire “loop.”

Wire bonding apparatuses, such as those disclosed in U.S. Pat. No. 5,402,927 (which is incorporated by reference herein in its entirety), include a wire feed system to supply a bonding wire to the bond head of the apparatus. The wire feed system includes a wire tensioner adjacent the capillary for tensioning the wire. In known wire tensioning devices, a flow of air is directed along the wire within the central bore of a tube to tension the wire.

Referring to FIG. 1, there is shown prior art wire tensioner 10 for a wire bonding apparatus. Wire tensioner 10 includes substantially cylindrical tubes 12, 14 maintained in an aligned fashion within body 16. Upper tube 12 is elongated compared to lower tube 14 and includes central bore 18 having a diameter that is constant throughout a majority of the tube. The bore diameter in upper tube 12 is sufficiently large to provide a gap between the inner surface of tube 12 and a wire that is received by tube 12. The gap between the wire and tube 12 allows air that is directed into bore 18 of tube 12 to flow axially along the wire resulting in tensioning of the wire. This axial flow of air along the wire results in a drag force causing tension in the portion of the wire positioned below wire tensioner 10.

Wire tensioner 10 also includes pressure supply 20 connected to inlet port 22 formed in body 16 of wire tensioner 10. Inlet port 22 communicates with annular plenum 24 defined between body 16 and a portion of upper tube 12 having a reduced outer diameter. Inlet gap 26, formed at an end of lower tube 14, communicates with plenum 24 to provide a flow path from plenum 24 into bore 18 of upper tube 12 for tensioning a wire in the above-described manner. As shown, lower tube 14 includes central bore 28 extending to inlet gap 26 and narrowing to constriction 30 at a lower end of lower tube 14. Constriction 30 is dimensioned to reduce the gap between tube 14 and a received wire sufficiently to minimize flow of air through constriction 30. In this manner, substantially all of the pressurized air that is directed into inlet port 22 from pressure supply 20, as shown by arrow 32, is forced to flow upwardly from inlet gap 26 in bore 18 of upper tube 12, as shown by arrow 34.

Wire tensioner 10 also includes wire inlet and outlet funnels 36, 38 respectively located at the upper and lower ends of tensioner 10. Wire inlet funnel 36 defines a central bore 40 aligned with central bore 18 of upper tube 12 for directing a wire to upper tube 12. As shown, bore 40 of wire inlet funnel 36 decreases in diameter from an upper end of inlet funnel 36, for example, to limit sharp surface transitions that would potentially damage a wire being fed into wire tensioner 10. In a similar fashion, wire outlet funnel 38 includes central bore 42 for discharging wire from wire tensioner 10. Central bore 42 of wire outlet funnel 38 has a diameter that increases towards a lower end, for example, to limit sharp transitions.

As shown by the path of arrow 34, air flowing through upper tube 12 is directed into bore 40 of wire inlet funnel 36 and is exhausted from wire tensioner 10 in an in-line fashion. The in-line exhausting of the air flow through wire inlet funnel 36 creates turbulence 11 in the air flow as it exits from tensioner 10. Such turbulence in the tensioning air flow causes undesirable wire vibration and spinning (see annotation XX on FIG. 1) that may impose torque and whipping disturbances to the wire being fed into the wire tensioner through wire inlet funnel 36. These torque and whipping disturbances of the wire adversely affects the bonding performance of the apparatus by forming loops that are distorted due to the wire damage caused by this turbulent air flow.

Referring to FIG. 2, there is shown another prior art wire tensioner 44. Wire tensioner 44 includes upper and lower tubes 46, 48 maintained in aligned fashion within body 50. Wire tensioner 44 also includes wire inlet and outlet funnels 52, 54. Upper tube 46 includes central bore 56 that is aligned with central bore 58 of wire inlet funnel 52. Lower tube 48 includes central bore 60 having a sufficient diameter to create a gap between tube 48 and a received wire to allow air to flow along the wire to tension the wire. Bore 56 of upper tube 46 reduces to constriction 64 located adjacent an end of tube 46. Constriction 64 is dimensioned to reduce the gap between tube 56 (should this be through central bore 56) and a received wire sufficiently to minimize flow of air through constriction 64. The configuration of wire tensioner 44, therefore, differs from that of wire tensioner 10 in which upper tube 12 defined the tensioning air flow gap and lower tube 14 defined the constriction.

Body 50 of wire tensioner 44 defines port 66 communicating with annular plenum 68 that is defined at an end of upper tube 46. Vacuum supply 70 is connected to port 66. As shown by arrow 72, air is drawn into wire outlet funnel 54 and lower tube 48 when a vacuum is applied to port 66. As shown by arrow 74, the air that is drawn into wire tensioner 44 enters through the bore defined by lower funnel 54 is exhausted from wire tensioner 44 through vacuum supply 70 (the actual vacuum supply is not illustrated in FIG. 2 but it is represented by reference numeral 70. Substantially no air enters through upper constriction 64, so that nearly all of the air flow is in the direction shown by arrow 72. Air flow 72 axially along the wire generates tension in the portion below wire tensioner 44 in a similar manner to that exhibited in wire tensioner 10.

The construction of vacuum based tensioner 44, and the resulting air flow path described above, may desirably eliminate the wire distortion associated with the in-line exhausting of pressure based tensioner 10 of FIG. 1. The amount of air flow, and the corresponding wire tension, that can be generated in vacuum based tensioner 44, however, is limited compared to that of pressure based tensioner 10. Further, because vacuum based tensioner 44 draws in un-filtered air from the outside environment, the tubes of vacuum based tensioner 44 also tend to utilize more frequent cleaning than those of pressure based tensioner 10.

Thus, it would be desirable to provide an improved wire tensioner that addresses one or more of the deficiencies of existing tensioners.

### SUMMARY OF THE INVENTION

According to an exemplary embodiment of the present invention, a wire tensioner for a wire bonding apparatus is provided. The wire tensioner includes a body structure defining a passage for receiving a wire, the passage including an inlet opening and an outlet opening through which the wire is configured to extend. The wire tensioner defines (1) an inlet port through which pressurized fluid is received into the wire tensioner, and (2) an exhaust port through which pressurized fluid is exhausted from the wire tensioner. The exhaust port is distinct from the inlet opening or the outlet opening of the body structure.

According to another exemplary embodiment of the present invention, a wire bonding apparatus is provided. The wire bonding apparatus includes a bonding tool adapted to receive a wire in a bonding tool passage defined therethrough. The wire bonding apparatus also includes a wire tensioner adjacent the bonding tool (other components, such as a wire clamp, may be provided between the adjacent wire tensioner and bonding tool). The wire tensioner includes a body structure defining a passage for receiving the wire, the passage including an inlet opening and an outlet opening through which the wire is configured to extend. The outlet opening extends adjacent the bonding tool passage such that the wire extends through the passage and into the bonding tool passage. The wire tensioner defines (1) an inlet port through which pressurized fluid is received into the wire tensioner, and (2) an exhaust port through which pressurized fluid is exhausted from the wire tensioner. The exhaust port is distinct from the inlet opening or the outlet opening of the body structure.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown. The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a conventional pressure based wire tensioner;

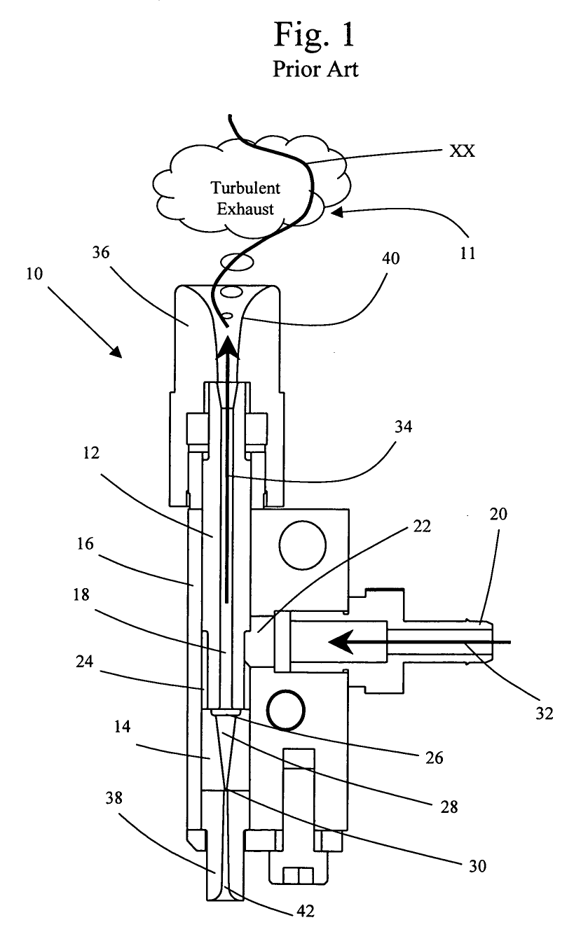

FIG. 2 is a conventional vacuum based wire tensioner;

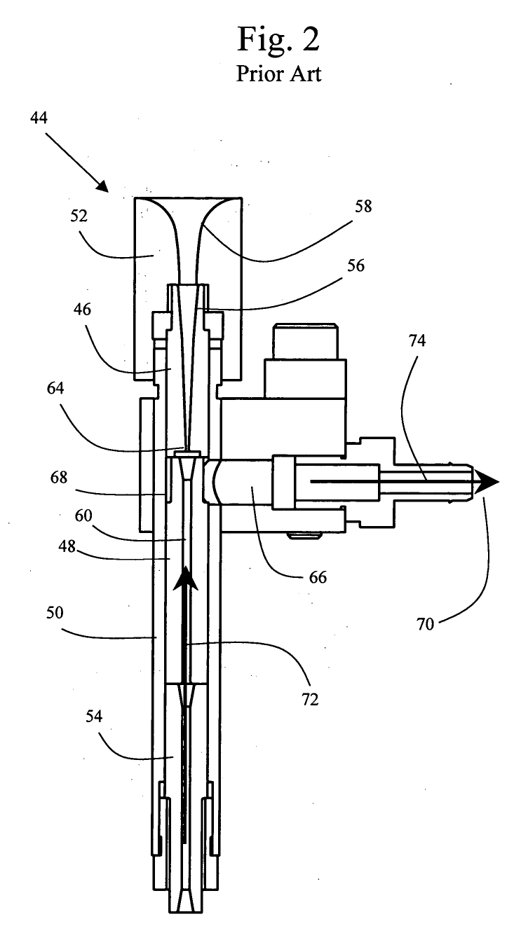

FIG. 3 is a schematic cut-away view of a wire tensioner according to an exemplary embodiment of the present invention;

FIG. 4 illustrates the air flow path through the wire tensioner of FIG. 3; and

FIG. 5 is a graphical illustration comparing the performance of the tensioner of FIGS. 3 and 4 to that of the pressure based tensioner of FIG. 1 and the vacuum based tensioner of FIG. 2.

### DETAILED DESCRIPTION OF THE DRAWINGS

According to an exemplary embodiment of the present invention, a wire tensioner for a wire bonding apparatus includes multiple ports communicating with a central tensioning bore of a wire tensioning tube. The multiple ports preferably include at least one inlet port for directing a flow of pressurized air from a source of pressurized air into the central tensioning bore and at least one exhaust port for exhausting the pressurized air from the central tensioning bore. The use of pressurized air as the means for creating a tensioning flow of air desirably provides the increased air flow and tension generating capabilities compared to vacuum based tensioners. The multiple port configuration of the present invention, which includes at least one outlet for exhausting the air flow from the wire tensioning bore (e.g., laterally exhausting the air flow from the wire tensioning bore), eliminates potential undesirable wire distortions such as torsion and whipping associated with prior pressured based wire tensioners which exhaust the tensioning air flow in an in-line fashion.

To provide the desired flow path for the wire tensioning air, the wire tensioner may include a pair of constrictions in the wire-receiving central bore. The constrictions may include an inlet constriction and an outlet constriction respectively arranged to direct pressurized air from the at least one inlet port to a wire-tensioning portion of the central bore and from the central bore to the at least one exhaust port.

According to certain exemplary embodiments, the wire tensioner of the present invention includes upper, intermediate and lower tubes maintained in a substantially aligned fashion with each other by a body. Each of the tubes defines a central bore in which a wire is received for tensioning by the wire tensioner. Inlet and exhaust ports are formed in the housing and extend substantially perpendicular to the central bore of the tubes adjacent opposite ends of the intermediate tube. Annular plenums are defined between the body and the intermediate tube at opposite ends of the intermediate tube. For example, the plenums may be formed by reduced outer diameter portions of the intermediate tube. The annular plenums respectively communicate with the inlet and exhaust ports formed in the body.

Each of the upper and lower tubes defines a gap (e.g. a slot) located at an end of the tube that is adjacent to the intermediate tube. The gaps provided at the ends of the upper and lower tubes provide a path for the pressurized air to flow between the inlet plenum and the central bore of the intermediate tube and between the intermediate tube and the exhaust plenum. The gaps provided by the upper and lower tubes may be arranged such that the flow paths in the inlet and exhaust plenums are substantially circuitous.

The central bore of the intermediate tube has a diameter that is sufficient to provide for a gap between the intermediate tube and a received wire such that the pressurized air can flow along the wire to tension the wire. The central bore of each of the upper and lower tubes reduces in diameter to respective constrictions such that the gap between the respective bore and the received wire is reduced sufficiently to minimize flow of the pressurized air through each constriction. The constrictions provided in the upper and lower tube ensure that substantially all of the pressurized air that is introduced into the inlet port will flow into the intermediate tube to tension the wire and that substantially all of the tensioning air flow in the intermediate tube will be exhausted (e.g., laterally) via the exhaust port.

For example, the wire tensioner also includes a wire inlet funnel and a wire outlet funnel located at opposite ends of the wire tensioner. The inlet and outlet funnels each include a central bore for receiving a wire. The bore of each of the funnels may taper in diameter to reduce and/or substantially eliminate sharp surface transitions that could damage a received wire.

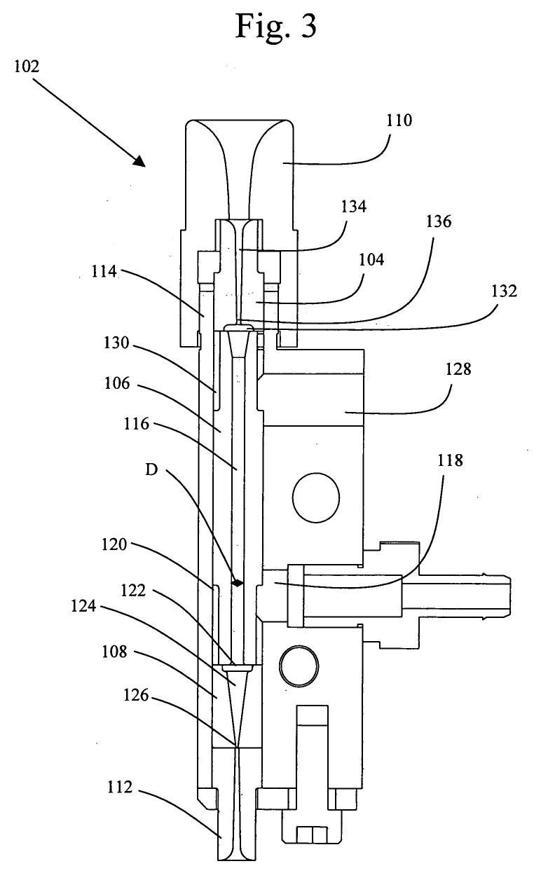

Referring to FIG. 3, there is shown wire tensioner 102 for a wire bonding apparatus according to an exemplary embodiment of the present invention. As described in greater detail below, wire tensioner 102 of the present invention may desirably utilize pressurized air, for increased wire tensioning capability compared to a conventional vacuum based wire tensioner, while reducing and/or substantially eliminating the undesirable wire distortion effects associated with conventional in-line exhaust pressure based wire tensioners. Wire tensioner 102 according to the illustrated embodiment of the present invention includes substantially cylindrical tubes 104, 106, 108, referred to hereinafter as upper tube 104, intermediate tube 106 and lower tube 108. As will become readily apparent hereinafter, the exterior of the tubes need not be cylindrical since the exterior has no effect on the tensioning of the wire. The interior of the tubes may desirably be substantially cylindrical in shape. Wire tensioner 102 also includes inlet and outlet funnels 110, 112 respectively located at upper and lower ends of wire tensioner 102. Directional terms such as “upper” and “lower” used herein refer to the orientation of wire tensioner 102 as it is shown in the figures to facilitate description of the invention. It should be understood, however, that the invention is not limited to any particular orientation of the tensioner.

Wire tensioner 102 includes body 114 in which tubes 104, 106, 108 are received and maintained in substantial alignment with each other. Intermediate tube 106 of wire tensioner 102 includes central bore 116 having a diameter sufficient to provide a gap between tube 106 and a wire that is received by tube 106 for tensioning. Body 114 of wire tensioner 102 includes inlet port 118. Inlet port 118 communicates with annular plenum 120 defined between intermediate tube 106 and body 114 by a portion of tube 106 having a reduced outer diameter. Lower tube 108 defines supply gap 122 at an thereof that communicates with both annular plenum 120 and central bore 116 of intermediate tube 106. Supply gap 122, therefore, provides a flow path for directing pressurized air into intermediate tube 106. Supply gap 122 and annular plenum 120 are arranged such that the flow path from the inlet port 118 is substantially circuitous.

Lower tube 108 of wire tensioner 102 includes central bore 124 narrowing to constriction 126. Constriction 126 is dimensioned to reduce the gap between tube 108 and a received wire sufficiently to minimize flow of air through constriction 126. Constriction 126, therefore, ensures that substantially all of the pressurized air will flow upwardly (relative to FIG. 3, but non-limiting) from supply gap 122 in central bore 116 of intermediate tube 106. As discussed above, air flowing along the wire in intermediate tube 106 of wire tensioner 102 results in tensioning of the portion of the wire that is located below wire tensioner 102.

Body 114 of wire tensioner 102 includes exhaust port 128 adjacent an end of intermediate tube 106. Exhaust port 128 communicates with annular plenum 130 defined between intermediate tube 106 and body 114 by a portion of tube 106 having a reduced outer diameter. Upper tube 104 defines exhaust gap 132 adjacent an end of tube 104 that communicates with plenum 130. Upper tube 104 includes central bore 134 that narrows to constriction 136 adjacent exhaust gap 132. Constriction 136 is dimensioned to reduce the gap between tube 104 and a received wire sufficiently to minimize flow of air through constriction 136 from intermediate tube 106. In this manner, the majority (and preferably substantially all) of the tensioning air flow is directed laterally, with respect to intermediate tube 106, and is exhausted from wire tensioner 102 via exhaust port 128.

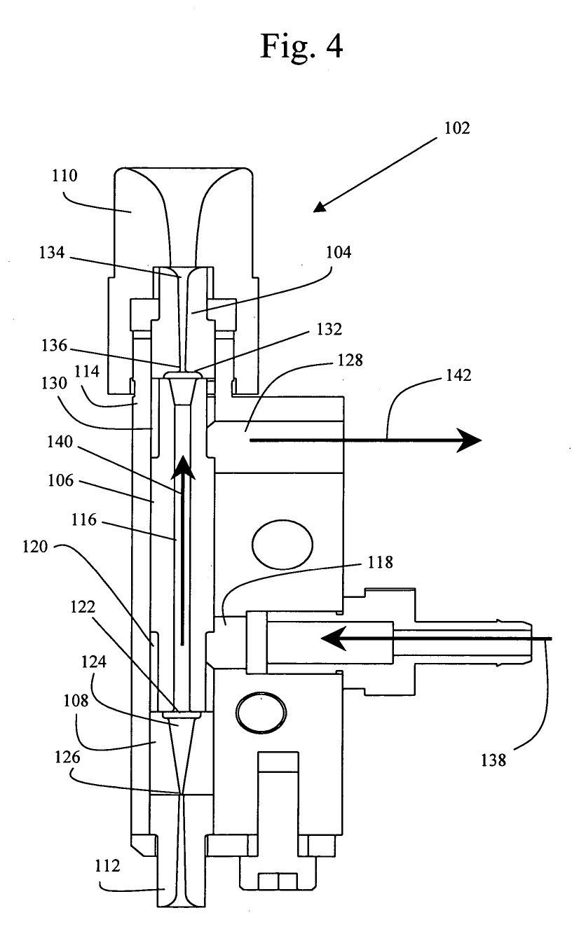

Referring to FIG. 4, the flow path for the tensioning air in wire tensioner 102 is illustrated. The pressurized air is introduced (e.g., from a pressure source not shown) into wire tensioner 102 through inlet port 118 as shown by arrow 138. The pressurized air is then directed into central bore 116 of intermediate tube 106 via inlet plenum 120 and supply gap 122. The pressurized air then travels upward (relative to FIG. 4) along a received wire in central bore 116 of intermediate tube 106 as shown by arrow 140. Upper constriction 136 substantially limits the pressurized air from passing into inlet funnel 110, thereby causing the air flow to be directed laterally through the exhaust gap 132, as shown by arrow 142 into exhaust port 128 to exit from wire tensioner 102.

The lateral exhausting of the tensioning air flow through exhaust port 128, as opposed to in-line exhausting via wire inlet funnel 110, desirably reduces and/or eliminates wire distortion, such as torsion and whipping, which is associated with prior pressure based wire tensioner 10.

The following describes a non-limiting example of wire tensioner 102 adapted to tension a 25 micron diameter wire. The diameter, D, of central bore 116 of intermediate tube 106 is, for example, approximately 0.40 mm to provide the necessary gap between tube 106 and a received wire to permit air flow along the wire to tension the wire as described above. The overall length of intermediate tube 106 is, for example, approximately 15 mm. The diameter of upper and lower constrictions 136, 126 may vary but may be, for example, between approximately 0.12 to 0.20 mm for reducing the gap around a 25 micron wire sufficiently to substantially limit air flow from passing through the constrictions. Inlet and exhaust ports 118, 128 may have a diameter of, for example, approximately 2 mm.

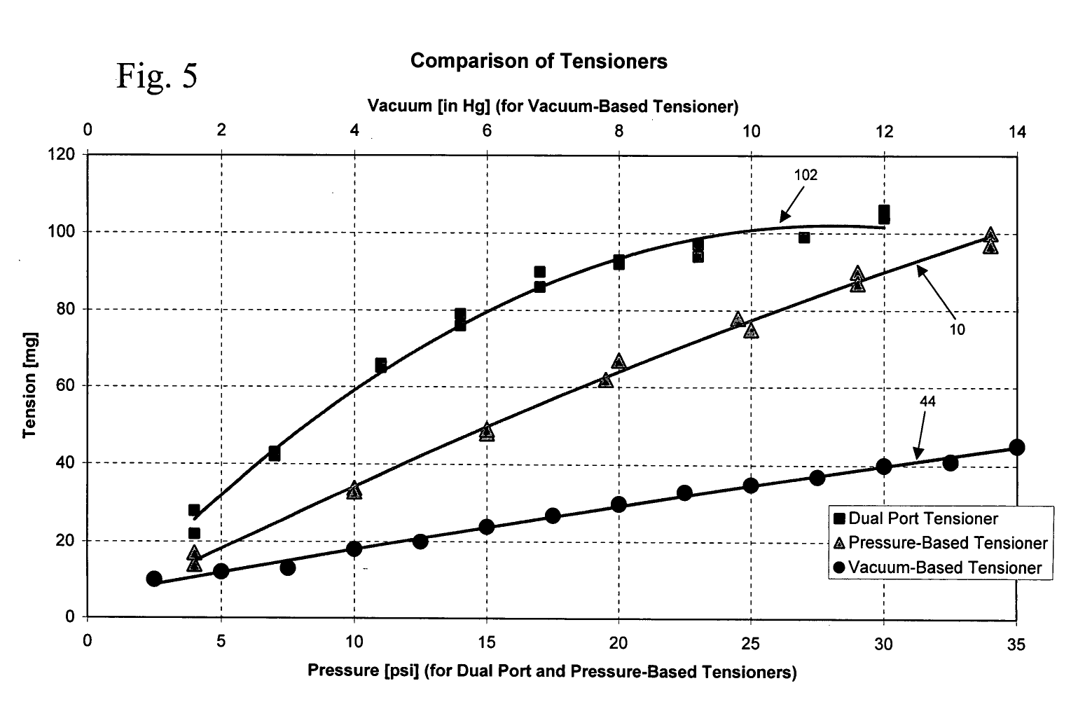

Referring to the graph of FIG. 5, the wire tensioning capability of the illustrated exemplary dual port wire tensioner 102 of the present invention is compared to that of prior pressure based wire tensioner 10 and prior vacuum based wire tensioner 44. The wire tension data represented in the graph of FIG. 5 is from testing conducted on a 25 micron diameter gold wire. For a given wire tensioner, as shown, the amount of tension that is generated on the wire may be changed by varying the pressure of the inlet air (for a pressure based wire tensioner) or the level of the applied vacuum (for a vacuum based wire tensioner). As described above, the tensioning capability of a vacuum based wire tensioner is limited, for example, because the amount of air flow that can be generated along the wire is limited. Therefore, as shown, the tension generating capability of prior vacuum based wire tensioner 44 is less than that of both prior pressure based wire tensioner 10 and dual port wire tensioner 102 of the present invention throughout the entire operating range of wire tensioner 44. As also shown, the tension generating capability of dual port wire tensioner 102 of the present invention throughout its entire operating range is greater than that of the prior pressure based wire tensioner 10 for any given inlet pressure.

Dual port wire tensioner 102 of the present invention, therefore, provides superior tensioning capability compared to both prior pressure based wire tensioner 10 and prior vacuum based wire tensioner 44 while substantially reducing and/or eliminating the undesirable wire distortions that are associated with prior pressure based wire tensioner 10.

As described above, dual port wire tensioner 102 of the present invention provides constrictions within the wire-receiving central bore of tensioner 102 and gaps defined between tubes that define the wire-receiving bore of tensioner 102. These constrictions and gaps may be arranged in the following exemplary sequence going from bottom to top of wire tensioner 102 (with respect to the orientation shown in the FIGS. 3-4).

1. Lower constriction to restrict air from exiting out of the bottom of the tensioner.

2. Air supply gap communicating air flow from the inlet plenum and inlet port.

3. Tension-generating portion of the central bore.

4. Air exhaust gap communicating air flow with the exhaust plenum and exhaust port.

5. Upper constriction to restrict air from exiting out the top of the tensioner.

While the present invention has been illustrated and described primarily with respect to an exemplary wire tensioning system, various modifications may be to the tensioner illustrated in FIGS. 3-4 within the scope of the present invention.

For example, while the illustrated wire tensioner, as described above, includes multiple tubes collectively defining the wire-receiving central bore of the wire tensioner, the present invention does not require a multiple tube construction. Alternative configurations are contemplated, for example, a single tube could define a central bore including upper and lower constrictions as well as gaps (or openings) that provide communication between the central bore and inlet and outlet ports of the wire tensioner.

While the present invention has been illustrated and described primarily with respect to an exemplary wire tensioning system having two ports, it is not limited thereto. The teachings herein may be applied to wire tensioning systems have two or more ports. For example, a wire tensioning system according to the present invention may have (1) one inlet port and two exhaust ports, (2) two inlet ports and one exhaust port, etc.

While the present invention has been illustrated and described primarily with respect to an exemplary wire tensioning system having ports in a specific configuration, it is not limited thereto. For example, while FIGS. 3-4 illustrate exhaust port 128 positioned to provide lateral exhausting, it is not limited to such a configuration.

While the present invention has been described primarily with respect to a positive air pressure being supplied to the wire tensioner via the inlet port, it is not limited thereto. A multiple port wire tensioner according to the present invention may also utilize a vacuum pressure between the inlet and outlet ports.

While the present invention has been described primarily with respect to air being the fluid, it is not limited thereto. Other fluids may be used, for example, certain gases (e.g., nitrogen, deionized air, etc.) may be appropriate.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A wire tensioner for a wire bonding apparatus, the wire tensioner comprising: a body structure defining a passage for receiving a wire, the passage including an inlet opening and an outlet opening through which the wire is configured to extend;
the wire tensioner defining an inlet port through which pressurized fluid is received into the wire tensioner, and
the wire tensioner defining an exhaust port through which pressurized fluid is exhausted from the wire tensioner, the exhaust port being distinct from the inlet opening or the outlet opening of the body structure.

2. The wire tensioner according to claim 1 wherein pressurized fluid is configured to be introduced into the passage via the inlet port, the body structure including at least two constrictions along the passage, the constrictions being configured such that a majority of a pressurized fluid entering the passage via the inlet port is exhausted via the exhaust port and does not pass through the constrictions toward the inlet opening and the outlet opening.

3. The wire tensioner according to claim 1, wherein the exhaust port is arranged substantially perpendicular to the passage.

4. The wire tensioner according to claim 1, wherein the pressurized fluid is arranged to have a positive pressure from the inlet port to the exhaust port.

5. The wire tensioner according to claim 1, wherein the pressurized fluid is arranged to have a vacuum pressure from the inlet port to the exhaust port.

6. The wire tensioner according to claim 1 wherein the body structure includes a plurality of tubes and an outer body portion, the plurality of tubes being arranged at least partially within the outer body portion such that bores defined by each of the tubes collectively define at least a portion of the passage.

7. The wire tensioner according to claim 6 wherein the plurality of tubes includes an inlet tube defining the inlet opening, an outlet tube defining the outlet opening, and an intermediate tube between the inlet tube and the outlet tube.

8. The wire tensioner according to claim 7 wherein the inlet port and the exhaust port are positioned such that a path of a majority of pressurized fluid provided through the inlet port flows (1) from the inlet port to the intermediate tube, and (2) from the intermediate tube to the exhaust port.

9. The wire tensioner according to claim 8 wherein a first constriction is defined by the inlet tube, and a second constriction is defined by the outlet tube.

10. The wire tensioner according to claim 7 wherein the intermediate tube has a reduced outer diameter at each of a first end and a second end, the inlet tube defining a slot at an end opposite the inlet opening, and the outlet tube defining a slot at an end opposite the outlet opening.

11. The wire tensioner according to claim 10 wherein a path of a majority of pressurized fluid is from (1) the inlet port toward the reduced outer diameter at the first end, (2) from the reduced outer diameter at the first end through the slot defined by the inlet tube, (3) through an interior of the intermediate tube, (4) through the slot defined by the outlet tube and towards the reduced outer diameter at the second end, and (5) from the reduced outer diameter at the second end through the exhaust port.

12. A wire bonding apparatus comprising:
a bonding tool adapted to receive a wire in a bonding tool passage defined therethrough; and
a wire tensioner adjacent the bonding tool, the wire tensioner including a body structure defining a passage for receiving a wire, the passage including an inlet opening and an outlet opening through which the wire is configured to extend, the outlet opening extending adjacent the bonding tool passage such that the wire extends through the passage and into the bonding tool passage, the wire tensioner defining (1) an inlet port through which pressurized fluid is received into the wire tensioner, and (2) an exhaust port through which pressurized fluid is exhausted from the wire tensioner, the exhaust port being distinct from the inlet opening or the outlet opening of the body structure.

13. The wire bonding apparatus according to claim 12 wherein pressurized fluid is configured to be introduced into the passage via the inlet port, the body structure including at least two constrictions along the passage, the constrictions being configured such that a majority of a pressurized fluid entering the passage via the inlet port is exhausted via the exhaust port and does not pass through the constrictions toward the inlet opening and the outlet opening.

14. The wire bonding apparatus according to claim 12, wherein the exhaust port is arranged substantially perpendicular to the passage.

15. The wire bonding apparatus according to claim 12, wherein the pressurized fluid is arranged to have a positive pressure from the inlet port to the exhaust port.

16. The wire bonding apparatus according to claim 12, wherein the pressurized fluid is arranged to have a vaccum pressure from the inlet port to the exhaust port.

17. The wire bonding apparatus according to claim 12 wherein the body structure includes a plurality of tubes and an outer body portion, the plurality of tubes being arranged at least partially within the outer body portion such that bores defined by each of the tubes collectively define at least a portion of the passage.

18. The wire bonding apparatus according to claim 17 wherein the plurality of tubes includes an inlet tube defining the inlet opening, an outlet tube defining the outlet opening, and an intermediate tube between the inlet tube and the outlet tube.

19. The wire bonding apparatus according to claim 18 wherein the inlet port and the exhaust port are positioned such that a path of a majority of pressurized fluid provided through the inlet port flows (1) from the inlet port to the intermediate tube, and (2) from the intermediate tube to the exhaust port.

20. The wire tensioner according to claim 19 wherein a first constriction is defined by the inlet tube, and a second constriction is defined by the outlet tube.

21. The wire tensioner according to claim 18 wherein the intermediate tube has a reduced outer diameter at each of a first end and a second end, the inlet tube defining a slot at an end opposite the inlet opening, and the outlet tube defining a slot at an end opposite the outlet opening.

22. The wire tensioner according to claim 21 wherein a path of a majority of pressurized fluid is from (1) the inlet port toward the reduced outer diameter at the first end, (2) from the reduced outer diameter at the first end through the slot defined by the inlet tube, (3) through an interior of the intermediate tube, (4) through the slot defined by the outlet tube and towards the reduced outer diameter at the second end, and (5) from the reduced outer diameter at the second end through the exhaust port.
